(19) United States
(12) Patent Application Publication
(10) Pub. No.: US 2026/0330962 A1
(43) Pub. Date: Oct. 22, 2026

(54) MEASUREMENT INFORMATION MANAGEMENT DEVICE, MEASUREMENT METHOD, AND MEASUREMENT INSTRUMENT

(71) Applicant: MITUTOYO CORPORATION, Kanagawa (JP)

(72) Inventors: Naoto NAKAMURA, Kanagawa (JP); Takashi YAMAGUCHI, Kanagawa (JP)

(73) Assignee: MITUTOYO CORPORATION, Kanagawa (JP)

(21) Appl. No.: 19/462,602

(22) Filed: Jan. 28, 2026

Related U.S. Application Data
(63) Continuation of application No. PCT/JP2024/024738, filed on Jul. 9, 2024.

(30) Foreign Application Priority Data
Aug. 4, 2023 (JP) 2023-128034

(51) Int. Cl. G08C 17/02; G01D 13/02

(52) U.S. Cl. CPC G08C 17/02; G01D 13/02; G08C 2201/30

(57) ABSTRACT

A measurement information management device includes a measurement information management circuitry that transmits a measurement command signal, receives a measurement result signal transmitted from each of a plurality of measurement instruments, and manages a plurality of measurement result signals. The measurement information management circuitry includes a first wireless transceiver that transmits the measurement command signal by a first communication scheme and receives the measurement result signal. The first wireless transceiver performs transmission of the measurement command signal a plurality of times at different timings using different radio frequency channels, and receives the measurement result signals transmitted at mutually different timings by second wireless transceivers included in the plurality of measurement instruments, respectively, according to a second communication scheme having a radio frequency band different from that of the first communication scheme.

### CROSS-REFERENCE TO RELATED APPLICATION

This application is based upon and claims the benefit of priority of the prior International Patent Application No. PCT/JP 2024/024738, filed on Jul. 9, 2024, which claims the benefits of priorities of Japanese Patent Application No. 2023-128034 filed on Aug. 4, 2023, the entire contents of which are incorporated herein by reference.

### FIELD

A certain aspect of embodiments described herein relates to a measurement information management device, a measurement method, and a measurement instrument.

### BACKGROUND

Conventionally, a measurement system is known which includes a plurality of measurement instruments, an information processing device that processes information output from each measurement instrument, and a transmission unit that transmits information between the measurement instruments and the information processing device (see, for example, Patent Literature 1: Japanese Patent Application Publication No. 2009-129416). Further, a technique of transmitting measurement data measured by a measurement instrument to a data processing device via a wireless medium is known (see, for example, Patent Literature 2: Japanese Patent Application Publication No. 2009-033422). Various other techniques for transmitting and receiving measurement information are proposed, and these proposals include a proposal for transmitting and receiving measurement information by a wireless medium (see, for example, Patent Literature 3: Japanese Patent Application Publication No. 2007-114906, Patent Literature 4: Japanese Patent Application Publication No. 2016-116210, Patent Literature 5: Japanese Patent Application Publication No. 2011-118727, Patent Literature 6: Japanese Patent Application Publication No. 2021-125794, and Patent Literature 7: International Publication Pamphlet No. WO 2009/148003).

A multipoint measuring apparatus used for measuring the shape of an object to be measured is known (see, for example, Patent Literature 8: Japanese Patent Application Publication No. 2013-200248). The multipoint measurement instrument includes a plurality of measurement instruments. In such a multipoint measuring apparatus, it is desirable that the measurement instruments perform measurement at the same timing as much as possible. Therefore, it is convenient if the exchange of information related to measurement can be transmitted and received by a wireless medium.

### SUMMARY

In an aspect, a measurement information management device includes a measurement information management circuitry that transmits a measurement command signal, receives a measurement result signal transmitted from each of a plurality of measurement instruments, and manages a plurality of measurement result signals, wherein the measurement information management circuitry includes a first wireless transceiver that transmits the measurement command signal by a first communication scheme and receives the measurement result signal, and wherein the first wireless transceiver performs transmission of the measurement command signal a plurality of times at different timings using different radio frequency channels, and receives the measurement result signals transmitted at mutually different timings by second wireless transceivers included in the plurality of measurement instruments, respectively, according to a second communication scheme having a radio frequency band different from that of the first communication scheme.

In addition, in the measurement information management apparatus having the above configuration, the first communication scheme may be a wireless scheme having a higher communication speed than a wireless scheme used in the second communication scheme.

In addition, in the measurement information management apparatus having the above configuration, the first communication scheme may be a broadcast communication scheme, and the second communication scheme may be a unicast communication scheme.

Moreover, in the measurement information management apparatus having the above configuration, the first wireless transceiver may set a time interval of the measurement command signal to a different time interval when the measurement command signal is executed a plurality of times.

In addition, in the measurement information management apparatus having the above configuration, the measurement information management circuitry may assign identifiers to the plurality of measurement instruments, and the first wireless transceiver may receive the measurement result signals sequentially transmitted based on the identifiers by the second wireless transceivers included in the measurement instruments that have successfully received the measurement command signal.

In the measurement information management apparatus having the above configuration, the first wireless transceiver may receive the measurement result signals retransmitted a plurality of times by the second communication scheme within a predetermined time.

In addition, in the measurement information management apparatus having the above configuration, the predetermined time may be changeable.

In the measurement information management apparatus having the above configuration, the first wireless transceiver may receive the measurement result signals equal to or less than a number corresponding to the number of times that the second wireless transceivers are capable of retransmitting within the predetermined time.

In another aspect, a measurement method includes executing, by a measurement information management circuitry, a measurement command signal according to a first communication scheme a plurality of times at different timings using different radio frequency channels, and receiving, by the measurement information management circuitry, measurement result signals obtained by wirelessly transmitting measurement results measured by a plurality of measurement instruments that have received the measurement command signal at mutually different timings by a second communication scheme having a radio frequency band different from that of the first communication scheme.

In still another aspect, a measurement instrument includes: a processor; and a measurement tool; wherein the processor is configured to: receive a measurement command signal transmitted a plurality of times from a measurement information management device by a first communication scheme while changing a radio frequency channel and a transmission timing; start measurement by the measurement tool in response to the measurement command signal to acquire a measurement result; and transmit a measurement result signal to the measurement information management device at a timing different from that of another measurement instrument by a second communication scheme having a radio frequency band different from that of the first communication scheme.

### BRIEF DESCRIPTION OF DRAWINGS

FIG. 1 is a block diagram schematically illustrating a schematic configuration of a measurement system according to a first embodiment.

FIG. 2 is a diagram illustrating an example of a hardware configuration of a measurement information management device included in the measurement system of the first embodiment.

FIG. 3 is a diagram illustrating an example of a hardware configuration of a measurement instrument included in the measurement system of the first embodiment.

FIG. 4 is a part of a flowchart illustrating an example of control performed by the measurement system of the first embodiment.

FIG. 5 is a part of a flowchart illustrating an example of control performed by the measurement system of the first embodiment.

FIG. 6 is a time chart illustrating an example of transmission and reception of signals in the measurement performed by the measurement system of the first embodiment.

FIG. 7 is a time chart illustrating another example of transmission and reception of signals in the measurement performed by the measurement system of the first embodiment.

FIG. 8 is a time chart illustrating still another example of transmission and reception of signals in the measurement performed by the measurement system of the first embodiment.

FIG. 9 is a time chart illustrating an example of transmission and reception of signals in measurement performed by the measurement system of a second embodiment.

FIG. 10 is a time chart illustrating another example of transmission and reception of signals in the measurement performed by the measurement system of the second embodiment.

FIG. 11 is a time chart illustrating still another example of transmission and reception of signals in the measurement performed by the measurement system of the second embodiment.

FIG. 12 is a block diagram schematically illustrating a schematic configuration of a measurement system according to a modification.

FIG. 13 is a diagram illustrating an example of a hardware configuration of a measurement information collection unit included in a measurement system according to the modification.

FIG. 14 is a diagram illustrating an example of a hardware configuration of an information transfer unit included in a measurement system according to the modification.

### DESCRIPTION OF EMBODIMENTS

By the way, in a measurement system including a plurality of measurement instruments, when various signals are exchanged via a wireless medium, interference of signals may be a problem. When the measurement system includes a plurality of measurement instruments, interference in the measurement system is assumed. In addition, interference may occur in the measurement system due to disturbances caused by the use environment of the measurement system. When such interference occurs, there is a possibility that appropriate acquisition of measurement information is inhibited.

In any of the above Patent Literatures, there is room for improvement as a countermeasure against interference in the measurement system.

In one aspect, the present invention is directed to efficiently acquire measurement information in a measurement system including a plurality of measurement instruments.

Hereinafter, embodiments will be described with reference to the drawings.

### First Embodiment

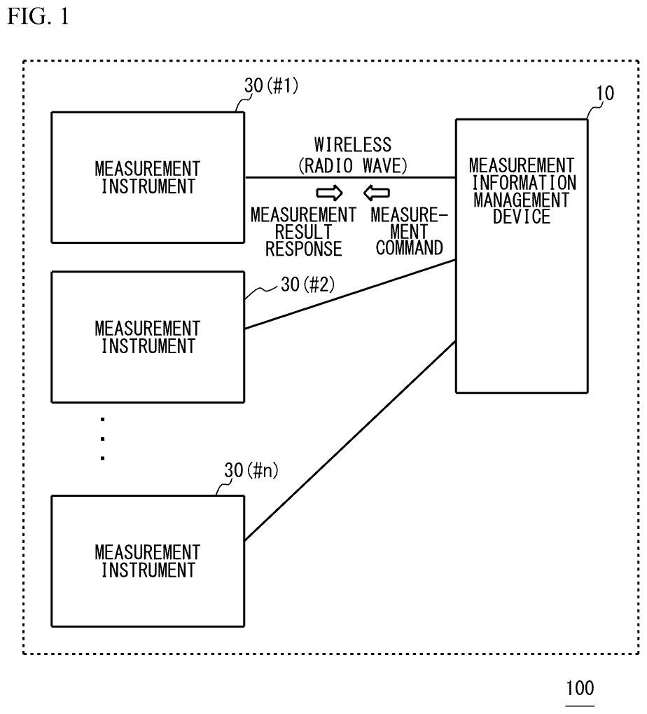

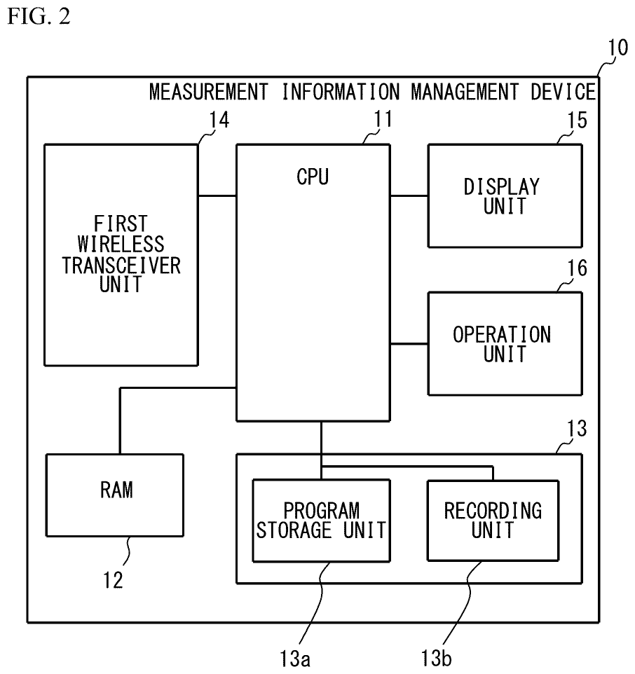

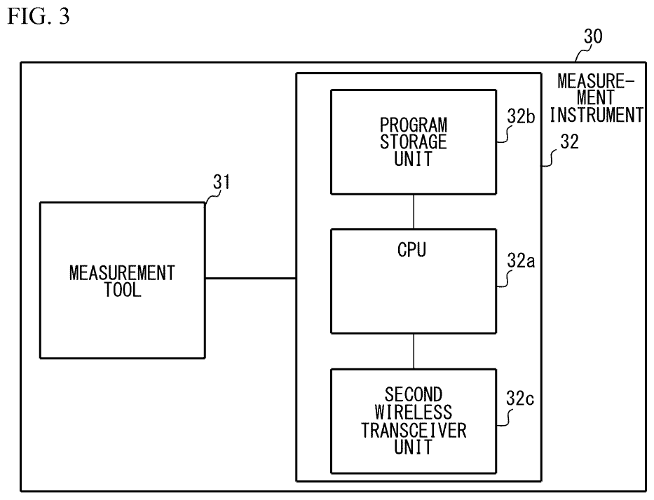

A schematic configuration of a measurement system 100 of a first embodiment will be described with reference to FIGS. 1 to 3. FIG. 1 is a block diagram schematically illustrating a schematic configuration of the measurement system 100 according to a first embodiment. FIG. 2 is a diagram illustrating an example of a hardware configuration of a measurement information management device 10 included in the measurement system 100 of the first embodiment. FIG. 3 is a diagram illustrating an example of a hardware configuration of a measurement instrument 30 included in the measurement system 100 according to the first embodiment.

### Measurement System

The measurement system 100 includes the measurement information management device 10 and a plurality of measurement instruments 30. The measurement instruments 30 may include any number of two or more measurement instruments. As described later, the plurality of measurement instruments 30 are numbered as an example of identifier assignment. In the following description, the reference numeral assigned to each measurement instrument is denoted by #. For example, the measurement instrument 30 with the number 1 may be denoted by #1, and the measurement instrument 30 with the number n may be denoted by #n. The measurement information management device 10 and the plurality of measurement instruments 30 can exchange signals wirelessly. In the present embodiment, numbers are assigned, but symbols other than the numbers may be used as long as the symbols are identifiers that can identify the plurality of measurement instruments 30.

The measurement system 100 can perform multipoint measurement by including the plurality of measurement instruments 30. The measurement instrument 30 is, for example, an indicator (a dial gauge). By providing a plurality of indicators and obtaining measurement values at multiple points, for example, the shape of the measurement target can be grasped.

### Measurement Information Management Device

As illustrated in FIG. 2, the measurement information management device 10 includes a first central processing unit (CPU) 11, a first random access memory (RAM) 12, a storage unit 13, a first wireless transceiver unit 14, a display unit 15, and an operation unit 16. The first CPU 11 is a central processor. The CPU 11 functions as a measured information management unit. The CPU 11 includes one or more cores. The RAM 12 is a volatile memory that temporarily stores programs executed by the CPU 11, date processed by the CPU 11, and the like. The storage unit 13 is a storage device. The storage unit 13 includes a program storage unit 13a and a recording unit 13b for recording the measurement result. The program stored in the program storage unit 13a is a system control program for controlling the entire measurement system 100. The storage unit 13 may include, for example, a read only memory (ROM), a solid state drive (SSD) such as a flash memory, a hard disk driven by a hard disk drive (HDD), or the like. The storage unit 13 uses these hardware components as appropriate according to the functions of the program storage unit 13a and the recording unit 13b.

The first wireless transceiver unit 14 transmits and receives signals to and from a second wireless transceiver unit 32c (see FIG. 3) included in each measurement instrument 30 described later. The communication scheme of the first wireless transceiver unit 14 will be described in detail later.

The display unit 15 is a liquid crystal display, an electroluminescence panel, or the like, and can display the measurement result. The operation unit 16 can set measurement conditions when performing measurement using the measurement system 100, and input an instruction when starting measurement. An operator can operate the operation unit 16 while referring to the information displayed on the display unit 15.

In the present embodiment, the operation of each unit included in the measurement information management device 10 is realized by executing a program, but hardware such as a dedicated circuit may be used.

### Measurement Instrument

Next, the measurement instrument 30 will be described. As illustrated in FIG. 3, the measurement instrument 30 includes a measurement tool 31 and a measurement tool control unit 32. The measurement tool 31 is, for example, an indicator, but may be another measurement tool such as a caliper or a micrometer. The measurement tool control unit 32 includes a second CPU 32a, a program storage unit 32b, and a second wireless transceiver unit 32c.

The second CPU 32a is a central processor. The program storage unit 32b stores a measurement tool program. The measurement tool program causes the measurement tool 31 to start measurement and causes the second wireless transceiver unit 32c to transmit the measurement result in conjunction with the system control program stored in the program storage unit 13a of the measurement information management device 10.

### Wireless Scheme

The first wireless transceiver unit 14 transmits a measurement command signal to the second wireless transceiver unit 32c included in each of the plurality of measurement instruments 30 (#1 to #n). The first wireless transceiver unit 14 receives a measurement result signal transmitted from the second wireless transceiver unit 32c. The second wireless transceiver unit 32c transmits the measurement result signal to the first wireless transceiver unit 14. The second wireless transceiver unit 32c receives the measurement command signal transmitted by the first wireless transceiver unit 14. Here, the measurement command signal transmitted by the first wireless transceiver unit 14 is transmitted by a first communication scheme. On the other hand, the measurement result signal transmitted by the second wireless transceiver unit 32c is transmitted by a second communication scheme. The first communication scheme is a wireless scheme having a higher communication speed than a wireless scheme used in the second communication scheme.

### First Wireless Scheme

The first wireless scheme is a broadcast communication scheme that enables simultaneous transmission. The measurement system 100 of the present embodiment is required to receive the measurement result signals measured from the plurality of measurement instruments 30 with little timing deviation as possible. Therefore, the first wireless transceiver unit 14 needs to transmit the measurement command signal to the plurality of measurement instruments 30 all at once. Therefore, in the present embodiment, a broadcast communication scheme is adopted as the first wireless scheme.

It is desirable that the communication speed of the measurement command signal is as fast as possible. Therefore, the first wireless scheme is a wireless scheme having a higher communication speed than the second communication scheme. However, the higher the communication speed, the more likely the influence of disturbances tends to be received. Therefore, in the present embodiment, the first wireless transceiver unit 14 performs simultaneous transmission a plurality of times at different timings using different radio frequency bands, that is, different wireless channels. The plurality of times of simultaneous transmission are all performed by the first wireless scheme, that is, the broadcast communication scheme. The use of different radio frequency bands can address disturbances in the environment in which the measurement system 100 is used. That is, by performing simultaneous transmission a plurality of times using different wireless frequency bands, it is possible to transmit the measurement command signal to each second wireless transceiver unit 32c while avoiding the influence of disturbances.

Note that, by using a wireless scheme with a high communication speed, the plurality of times of re-transmission can be completed in a short time.

As a wireless protocol used in the first wireless scheme, a short-range wireless communication technique, for example, Bluetooth (registered trademark) Low Energy can be used. The plurality of times of the simultaneous transmission can be realized by executing an advertisement transmitted by broadcast. Note that the communication speed in Bluetooth (registered trademark) Low Energy is substantially about 50 kbps. Bluetooth (registered trademark) low energy uses the 2.4 GHz band as a communication frequency, and can be used in Japan without a license as long as the output is equal to or lower than 10 mW. Further, although Bluetooth (registered trademark) Low Energy can achieve a reach distance equal to or less than 50 m, the practical reach distance is about 5 m. Bluetooth (registered trademark) low energy has a characteristic that a delay time required for searching for devices and communication is less than a 10 msec and is short. The radio frequency band depends on the wireless scheme, and the communication speed also depends on the wireless scheme.

### Second Wireless Scheme

The second wireless scheme is a unicast communication scheme that enables highly reliable communication. A signal transmitted by the second wireless transceiver unit 32c is the measurement result signal. That is, since the measurement itself in the measurement instrument 30 is completed, it is important to transmit the measurement data with high reliability. The slower the communication speed, the more resistant to disturbances and the higher the reliability of wireless communication. Therefore, the second wireless scheme is a wireless scheme having a communication speed lower than that of the first wireless scheme. This makes it possible to cope with disturbances in an environment in which the measurement system 100 is used.

Since the radio frequency band used by the first wireless transceiver14 and the radio frequency band used by the second wireless transceiver unit 32c are different, interference between the measurement command signal and the measurement result signal is avoided.

It is also convenient that the second wireless scheme has an arrival confirmation function or a re-transmission function. By using the re-transmission function, the timings at which the plurality of second wireless transceiver units 32c transmit the measurement result signals can be shifted. The timings at which the plurality of second wireless transceiver units 32c transmit the measurement result signals are assigned to different re-transmission timings. Accordingly, the measurement result signals are transmitted at different timings, and interference between the measurement result signals is avoided.

As a wireless protocol used in the second wireless scheme, for example, Zigbee (registered trademark) can be used. Since a wireless channel can be set in Zigbee (registered trademark), a channel other than the channel used in the first wireless scheme can be set. Note that the communication speed in Zigbee (registered trademark) is substantially about 10 to 20 kbps.

### Measurement Control

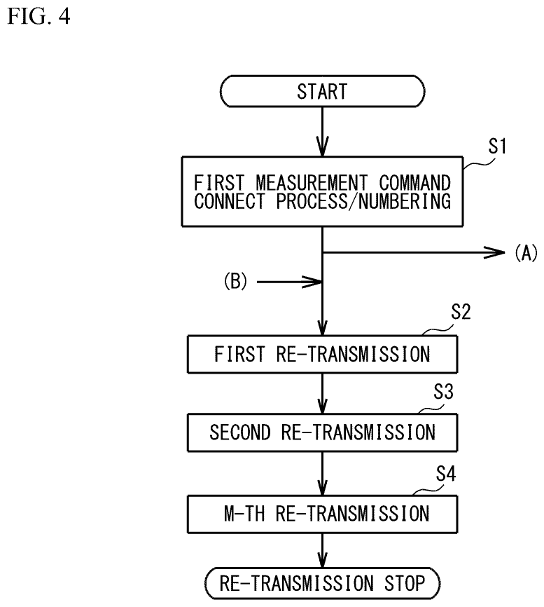

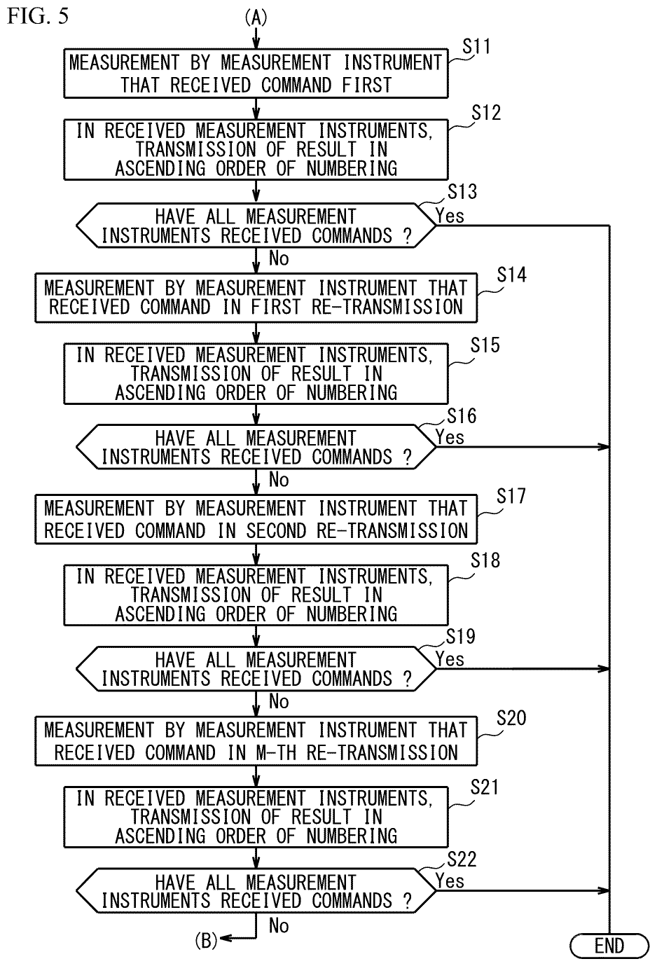

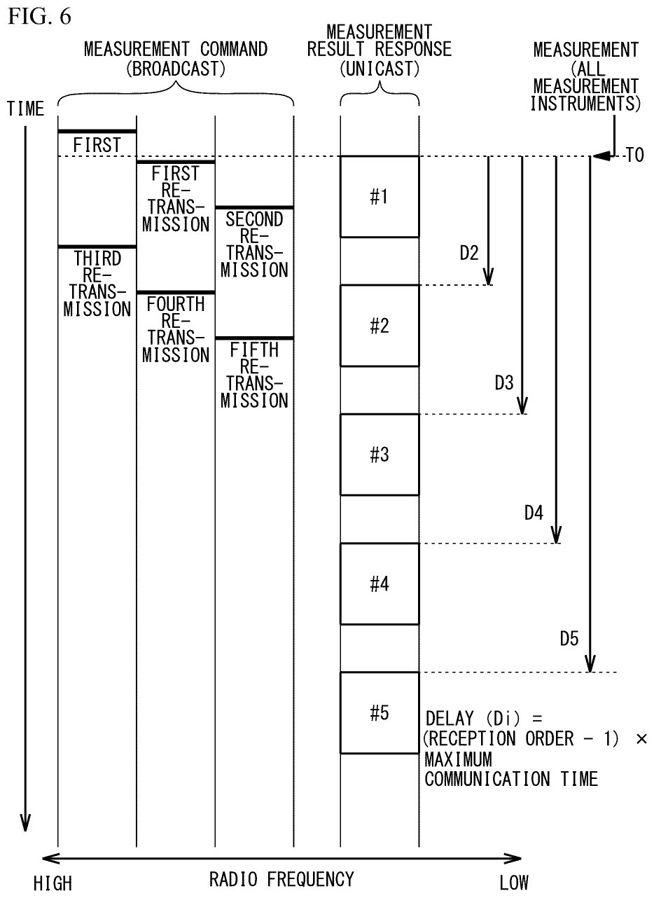

Next, an example of control of each unit during measurement using the measurement system 100 of the present embodiment will be described with reference to FIGS. 4 to 8. Each of FIGS. 4 and 5 is a part of a flowchart illustrating an example of control performed by the measurement system 100 of the first embodiment. In FIGS. 4 and 5, one flowchart is divided into two diagrams for convenience of drawing. The reference sign (A) in FIG. 4 is connected to the reference sign (A) in FIG. 5. The reference sign (B) in FIG. 5 is connected to the reference sign (B) in FIG. 4. FIGS. 6 to 8 are time charts illustrating examples of transmission and reception of signals in the measurement performed by the measurement system of the first embodiment. FIGS. 6 to 8 illustrate examples in which the reception states of the measurement command signal are different. In the example illustrated in FIGS. 6 to 8, five measurement instruments 30 as #1 to #5 are provided.

First, the outline of the measurement control will be described. The measurement control includes steps S1 to S4 relating to the transmission of the measurement command signal illustrated in FIG. 4 and steps S11 to S22 relating to the transmission of the measurement result signal illustrated in FIG. 5.

Step S1 is a step of initially transmitting the measurement command signal. The steps S2 to S4 are steps for retransmitting the measurement command signal. The number of re-transmissions can be set freely. However, the number of re-transmissions is set in consideration of time resolution that can be regarded as simultaneous measurement in the measurement system 100. In FIG. 4, the number of re-transmissions is m times. In the example illustrated in FIG. 6 and the like, the number of re-transmissions is set to five times.

Intervals at which the measurement command signals are transmitted can be set as appropriate. In the present embodiment, an interval between first transmission and first re-transmission, an interval between the first re-transmission and second re-transmission, an interval between third re-transmission and fourth re-transmission, and an interval between the fourth re-transmission and fifth re-transmission are the same as each other. An interval between the second re-transmission and the third re-transmission is longer than the other transmission intervals. This is in consideration of securing time for receiving the measurement result signal. Further, by setting the interval between the second re-transmission and the third re-transmission longer than the other intervals, it is possible to suppress power consumption. Note that the interval set longer than the other intervals is not limited to the interval between the second re-transmission and the third re-transmission, and can be selected as appropriate. That is, the transmission interval can be set as appropriate.

The radio frequency used in the first transmission and the radio frequency used in the first re-transmission are different from each other. The radio frequency used in the second re-transmission is different from the radio frequency used in the first transmission and the radio frequency used in the first re-transmission. This is in consideration of the disturbances in the environment in which the measurement system 100 is used. When there is a radio wave that is the disturbances in the environment in which the measurement system 100 is used, if the radio wave and the measurement command signal interfere with each other, the measurement command signal cannot maintain a normal form, and it may be discarded as an error packet in which the format is incorrect. In addition, it is also assumed that the radio control mechanism of the lowest layer determines that there is no vacancy in the radio space, and transmission cannot be started within a specified time, and thus, the radio control mechanism is timed out and the measurement command signal is discarded. There is a high possibility that the different radio frequencies include a frequency that does not interfere with the radio wave that is the disturbances. This makes it possible to appropriately transmit the measurement command signal.

Each measurement instrument 30 starts the measurement and obtains a measurement result when the second wireless transceiver unit 32c receives the measurement command signal. The measurement result signal for transmitting the measurement result is sequentially transmitted by repeating the transmission of the unicast communication scheme. Referring to FIG. 6, the first transmission of the measurement result signal is performed at time T0. The time T0 is set to a timing at which the measurement is performed after the measurement command signal transmitted first is received and the measurement result signal can be transmitted. The first re-transmission by the repeated transmission is executed at a time point when a delay time D2 has elapsed from the time T0. Similarly, the second re-transmission is executed at a time point when a delay time D3 has elapsed from the time T0. Similarly, the third re-transmission is executed at a time point when a delay time D4 has elapsed from the time T0, and the fourth re-transmission is executed at a time point when a delay time D5 has elapsed from the time T0.

Note that FIG. 6 illustrates an example in which all of the five measurement instruments 30 successfully receive the measurement command signals by the first transmission. Therefore, at the time T0, all the measurement instruments 30 are in a state capable of transmitting the measurement result signals. However, if the measurement result signals are transmitted all at once, the measurement result signals may interfere with each other. Therefore, in the present embodiment, the measurement result signal is transmitted at a shifted transmission time by performing repeated transmission.

A delay time Di is (reception order−1)×maximum communication time. The reception order may be the order of numbering described later when there are measurement instruments 30 that have succeeded in reception at the same time as in the example illustrated in FIG. 6. The maximum communication time is a predetermined time set in the unicast communication scheme. That is, the maximum communication time is determined by the specification of the adopted unicast communication scheme. The maximum communication time can be set as appropriate according to the environment in which the measurement system 100 is used. For example, when the measurement system 100 is used in an environment where the communication environment is not good, the maximum communication time can be set to be longer. The maximum communication time can be set in consideration of the interval at which the measurement command signal is transmitted.

In the unicast communication scheme, re-transmission can be performed a plurality of times within one maximum communication time. In the examples illustrated in FIGS. 6 to 8, one transmission is performed within one maximum communication time, but the plurality of re-transmissions may be performed within one maximum communication time. This aspect will be described later as a second embodiment.

Next, the measurement control will be described with reference to the flowcharts illustrated in FIGS. 4 and 5.

The operator operates the operation unit 16 (see FIG. 2) to start measurement by the measurement system 100. The measurement information management device 10 included in the measurement system 100 transmits a first measurement command signal in step S1. The measurement command signals are transmitted all at once by the first wireless transceiver unit 14 using a broadcast communication scheme. At this time, the measurement information management device 10 performs a connection process with each of the measurement instruments 30. Each measurement instruments 30 is numbered. In the present embodiment, numbers #1 to #5 are assigned to the five measurement instruments 30.

When the measurement system 100 starts the measurement, the measurement information management device 10 executes the process of step S1 in parallel with step S11. In step S11, the measurement instruments 30 that can receive the first measurement command signal transmitted in step S1 execute the respective measurements. In the example illustrated in FIG. 6, since it is assumed that all the measurement instruments 30 successfully receive the first measurement command signals, the measurement instruments 30 of #1 to #5 execute the measurements all at once.

Then, in step S12, the measurement instruments 30 that have received the first measurement command signal transmits the measurement result signals in ascending order of the numbering. In the example illustrated in FIG. 6, the measurement result signals are transmitted in the order of #1 to #5. That is, the measurement result signal of #1 is transmitted at the time T0. When the delay time D2 has elapsed, the measurement result signal of #2 is transmitted. When the delay time D3 has elapsed, the measurement result signal of #3 is transmitted. When the delay time D4 has elapsed, the measurement result signal of #4 is transmitted. When the delay time D5 has elapsed, the measurement result signal of #5 is transmitted.

In step S13, the measurement information management device 10 determines whether all the measurement instruments 30 have received the measurement command signals and completed the measurements. When the determination result is positive (Yes) in step S13, the measurement information management device 10 ends the process. When the determination result is negative (No) in step S13, the measurement information management device 10 proceeds to step S14.

The measurement information management device 10 performs the process of step S2 following step S1. The measurement information management device 10 performs the first re-transmission of the measurement command signal in step S2. Thereafter, the measurement information management device 10 performs the second re-transmission in step S3. Finally, m-th re-transmission is performed (step S4=m-th re-transmission). In the present embodiment, the re-transmissions up to the fifth time are sequentially performed (step S4=fifth re-transmission). When the processes up to step S4 are completed, the measurement information management device 10 temporarily stops the re-transmission of the measurement command signal.

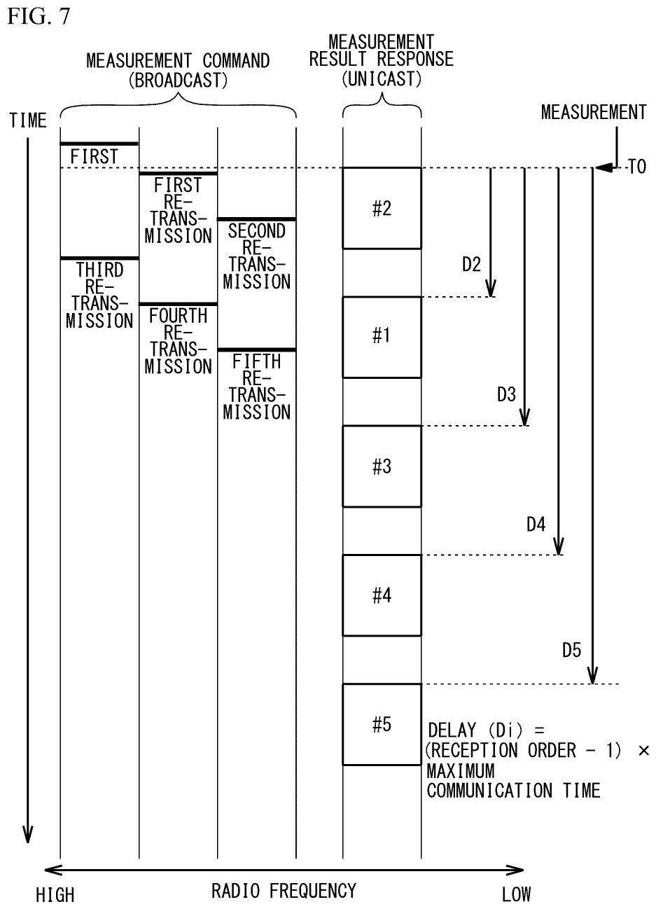

On the other hand, in step S14, the measurement instrument 30 that has successfully received the measurement command signal in the first re-transmission performs the measurement. The example illustrated in FIG. 7 indicates a case where the measurement instrument 30 of #1 could not receive the measurement command signal in the first transmission of the measurement command signal. In the example illustrated in FIG. 7, as the process of step S12, the measurement instrument 30 of #2 transmits the measurement result signal at time T0. Therefore, when the measurement instrument 30 of #1 can receive the first measurement command signal by re-transmission, the measurement result signal of the measurement instrument 30 of #1 is transmitted at the time when the delay time D2 has elapsed as the process of step S15.

In the example illustrated in FIG. 7, it is also assumed that the measurement instruments 30 of #3 and #4 have succeeded in reception by the first transmission of the measurement command signal. Even in such a case, when the first re-transmission of the measurement command signal is performed at the timing when the delay time D2 has not elapsed and the measurement instrument 30 of #1 is in a state capable of transmitting the measurement result signal, the measurement instrument 30 of #1 performs the transmission in preference to the measurement instrument 30 of #3.

That is, the transmission is executed in ascending order of the number of the measurement instruments 30 that can be in time for the transmission of the measurement result signal. In the example illustrated in FIG. 7, the process after the delay time D3 is common to that in the example illustrated in FIG. 6.

In step S16 to be performed following step S15, the measurement information management device 10 determines whether all of the measurement instruments 30 have received the measurement command signals and completed the measurements, in the same manner as the process in step S13. When the determination is affirmative in step S16, the measurement information management device 10 ends the process. When the determination result is negative in step S16, the measurement information management device 10 proceeds to step S17.

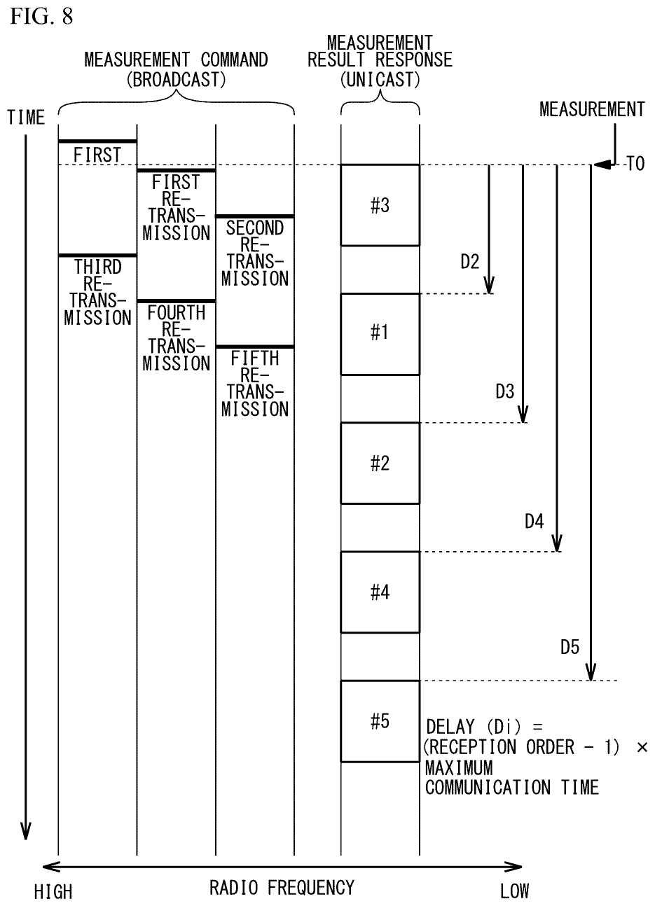

In step S17, the measurement instrument 30 that has successfully received the measurement command signal in the second re-transmission performs the measurement. The example illustrated in FIG. 8 indicates a case where the measurement instruments 30 of #1, #2, #4, and #5 cannot receive the measurement command signal in the first transmission of the measurement command signal. That is, in the example illustrated in FIG. 8, only the measurement instrument 30 of #3 successfully receives the measurement command signal in the first transmission of the measurement command signal. Therefore, in the example illustrated in FIG. 8, the measurement instrument 30 of #3 transmits the measurement result signal at the time S12 as the process of step T0. When the measurement instrument 30 other than #3 can receive the measurement command signal by the second re-transmission of the measurement command signal, the measurement result signal of the measurement instrument 30 of #1 is transmitted at the time when the delay time D2 has elapsed as the process of step S18. Then, after the delay time D3, the measurement result signals of the measurement instruments 30 of #2, #4, and #5 are sequentially transmitted.

In step S19 to be performed following step S18, the measurement information management device 10 determines whether all of the measurement instruments 30 have received the measurement command signals and completed the measurements, in the same manner as the process in step S13. When the determination is affirmative in step S19, the measured information management device 10 ends the process. When the determination result is negative in step S19, the measurement information management device 10 proceeds to step S20.

Steps S20, S21 and S22 indicate that the m-th re-transmission is processed in the same manner as the previous re-transmissions. In the example illustrated in FIGS. 6 to 8, since the number of re-transmissions is five, the process is repeated until m=5.

When the determination is negative in step S22, the measurement information management device 10 repeats the process from step S2 again. This is because it is assumed that, depending on the environment in which the measurement system 100 is used, the measurement by all the measurement instruments 30 is not completed even if a series of re-transmission processes is performed. In such a case, the processes from step S2 to step S4 and the processes from step S11 to step S22 are repeated again. In the case of processes of second times and subsequent times, the processes from step S11 to step S13 may be skipped and the processes from step S14 and subsequent steps may be performed.

In the measurement system 100 of the present embodiment, the first wireless transceiver unit 14 performs simultaneous transmission of measurement command signals a plurality of times at different timings using different radio frequency bands. Therefore, it is possible to transmit the measurement command signal without being affected by disturbances in the environment in which the measurement system 100 is used.

The measurement system 100 transmits the measurement command signal in the first communication scheme and transmits the measurement result signal in the second communication scheme. Therefore, interference between the measurement command signal and the measurement result signal can be avoided.

Further, the measurement system 100 uses a wireless scheme that is resistant to disturbances as the second communication scheme. This makes the transmission of the measurement result signal less susceptible to disturbances.

The measurement system 100 transmits the measurement result signals at different timings. This makes it possible to avoid interference between the measurement result signals.

### Second Embodiment

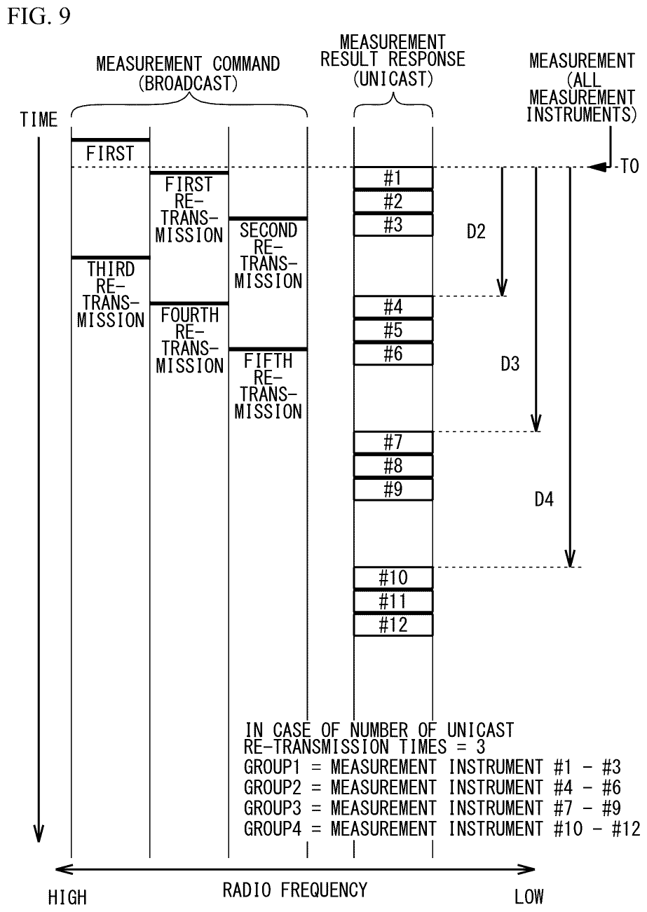

Next, a second embodiment will be described with reference to FIGS. 9 to 11. In the first embodiment, in the unicast communication scheme, one transmission is performed within one maximum communication time. In contrast, in the second embodiment, a plurality of times of re-transmission are performed within one maximum communication time. That is, the plurality of times of re-transmission is performed within a predetermined time. Referring to FIG. 9, the transmission of the measurement result signals for #1 to #3 is performed during a period until the delay time D2 is reached. That is, the plurality of times of re-transmission are performed within one maximum communication time. The plurality of times of re-transmission are performed even during a period from a time when the delay time D2 has elapsed to a time when the delay time D3 has elapsed. Further, the plurality of times of re-transmission are performed even during a period from a time when the delay time D3has elapsed to a time when the delay time D4 has elapsed.

The hardware configuration of the second embodiment is the same as that of the first embodiment, and thus the detailed description thereof will be omitted.

In the second embodiment, twelve measurement instruments 30 from #1 to #12 are prepared. These measurement instruments 30 are divided into four groups from Group 1 to Group 4 so that the number of measurement instruments 30 belonging to one group is three. Here, the number of measurement instruments 30 belonging to one group is three in consideration of the number of times that re-transmission can be performed within the maximum communication time. For example, when the number of times of re-transmission that can be performed within the maximum communication time is four, the number of measurement instruments 30 belonging to one group is set to four or less. In this way, the second wireless transceiver units 32c, the number of which is equal to or less than the number corresponding to the number of times that the re-transmission can be performed within the predetermined time, transmit the measurement result signals within the predetermined time, and thus it is possible to efficiently transmit the measurement result signals. In the present embodiment, the number of times that re-transmission is possible within the maximum communication time is set to four, and the number of measurement instruments 30 belonging to one group is set to three so that the number of measurement instruments 30 is four or less.

The example illustrated in FIG. 9 is an example of a case where all the measurement instruments 30 successfully receive the measurement command signal by the transmission of the first measurement command signal. Therefore, at the time of the time T0, the measurement of all the measurement instruments 30 is completed. Then, the measurement result signals of the measurement instruments 30 of #1 to #3 belonging to Group 1 are sequentially transmitted from the time T0. Further, the measurement result signals of the measurement instruments 30 of #4 to #6 belonging to Group 2 are sequentially transmitted from the time point when the delay time D2 has elapsed. Further, the measurement result signals of the measurement instruments 30 of #7 to #9 belonging to Group 3 are sequentially transmitted from the time point when the delay time D3 has elapsed. Then, the measurement result signals of the measurement instruments 30 of #10 to #12 belonging to Group 4 are sequentially transmitted from the time point when the delay time D4 has elapsed.

In this way, by performing the plurality of times of re-transmission within the maximum communication time, it is possible to transmit a large number of measurement result signals.

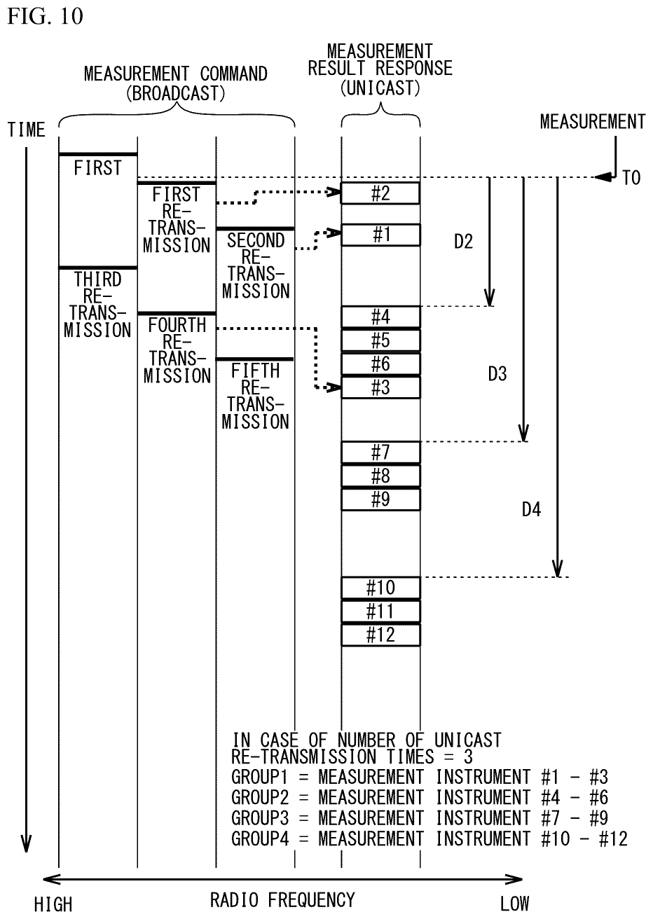

The example illustrated in FIG. 10 is an example of a case where the measurement instruments 30 of #1 to #3 cannot receive the first measurement command signal. It is assumed that the measurement instrument 30 of #2 successfully receive the first measurement command signal in the first re-transmission, and the measurement instrument 30 of #1 successfully receive the first measurement command signal in the second re-transmission. It is also assumed that the measurement instrument 30 of #3 successfully receive the first measurement command signal in the fourth re-transmission. It is assumed that the measurement instruments 30 of #4 to #12 successfully receive the first measurement command signal.

In this case, the measurement instruments 30 of #2 and #1 which have completed the measurements in the period from the time T0 to the delay time D2, transmit the measurement result signals in the period from the time T0 to the delay time D2. At this time, since the measurement instrument 30 of #2 receives the measurement command signal earlier than the measurement instrument 30 of #1, the measurement instrument 30 of #2 also transmits the measurement result signal earlier than the measurement instrument 30 of #1.

The measurement instrument 30 of #3 receives the measurement command signal in the fourth re-transmission. However, the measurement of the measurement instrument 30 of #3 is not in time for the delay time D2. Therefore, the measurement result signal of the measurement instrument 30 of #3 is transmitted during the period from the delay time D2 to the delay time D3 together with the measurement instruments 30 of #4 to #6 included in Group 2. However, the measurement instruments 30 of #4 to #6 complete the reception earlier than the measurement instrument 30 of #3. Therefore, the measurement result signal of the measurement instrument 30 of #3 is retransmitted after the transmission of the measurement result signal of the measurement instrument 30 of #6. In the present embodiment, since the re-transmission can be performed four times within the maximum communication time, the transmission of the measurement instrument 30 of #3 can be included in the period from the delay time D2 to the delay time D3.

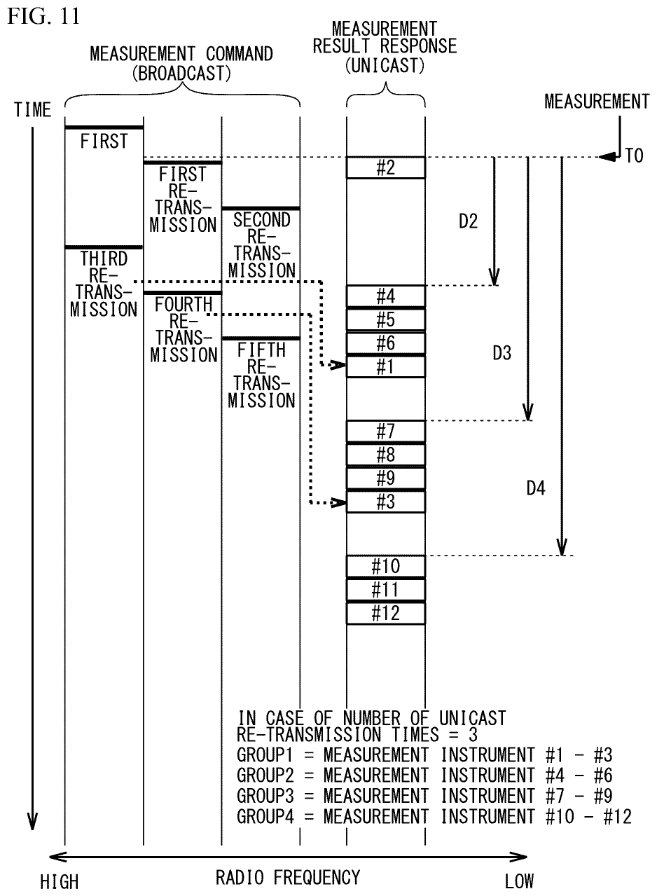

The example illustrated in FIG. 11 is an example of a case where the measurement instruments 30 of #1 and #3 could not receive the first measurement command signal. It is assumed that the measurement instrument 30 of #1 successfully receives the first measurement command signal in the third re-transmission, and the measurement instrument 30 of #3 successfully receives the first measurement command signal in the fourth re-transmission. It is assumed that the measurement instruments 30 of #2 and #4 to #12 successfully receive the first measurement command signal.

In this case, the measurement instrument 30 of #2 that has completed reception by the first transmission of the measurement command signal transmits the measurement result signal at time T0. Next, the measurement result signal of the measurement instrument 30 of #1 that has been successfully received in the third re-transmission is transmitted during a period from the delay time D2 to the delay time D3 together with the measurement instruments 30 of #4 to #6 included in Group 2. However, the measurement instruments 30 of #4 to #6 complete the reception earlier than the measurement instrument 30 of #1. Therefore, the measurement result signal of the measurement instrument 30 of #1 is retransmitted after the transmission of the measurement result signal of the measurement instrument 30 of #6.

The measurement result signal of the measurement instrument 30 of #3 that has been successfully received in the fourth re-transmission is transmitted in a period from the delay time D3 to the delay time D4 together with the measurement instruments 30 of #7 to #9 included in Group 3. However, the measurement instruments 30 of #7 to #9 complete the reception earlier than the measurement instrument 30 of #3. Therefore, the measurement result signal of the measurement instrument 30 of #3 is retransmitted after the transmission of the measurement result signal of the measurement instrument 30 of #9. The measurement instrument 30 of #3 also completes the measurement by the delay time D3, similarly to the measurement instrument 30 of #1. However, the period from the delay time D2 to the delay time D3already includes the measurement instrument 30 of #1, and four measurement instruments 30 are allocated to the period. Therefore, the measurement instrument 30 of #3 is allocated to the next opportunity.

These are merely examples, and there are innumerable reception patterns of the measurement command signal, but the measurement can be efficiently completed by sequentially transmitting the measurement result signal in these manners.

### Modification

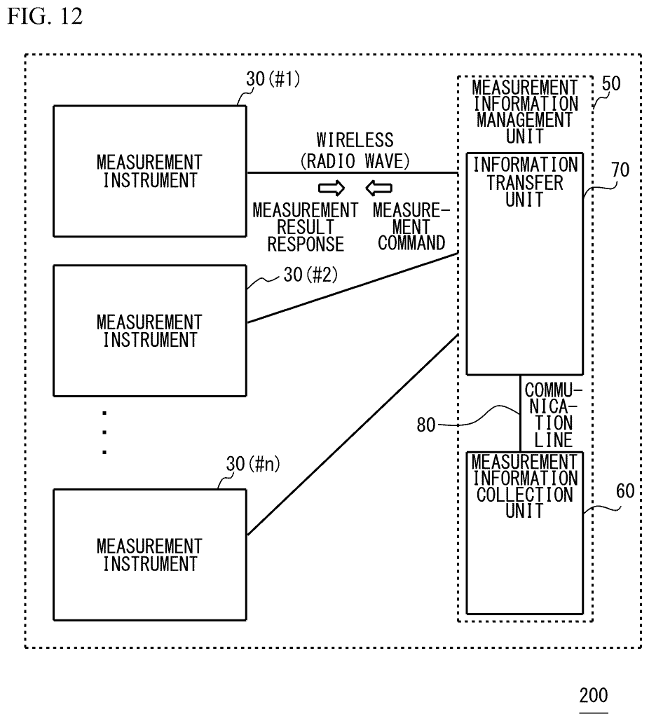

Next, a measurement system 200 of a modification will be described with reference to FIGS. 12 to 14. A measurement information management unit 50 included in the measurement system 200 of the modification includes a measurement information collection unit 60, an information transfer unit 70, and a communication line 80 connecting these units. The communication line 80 may be a wireless communication line or a wired communication line.

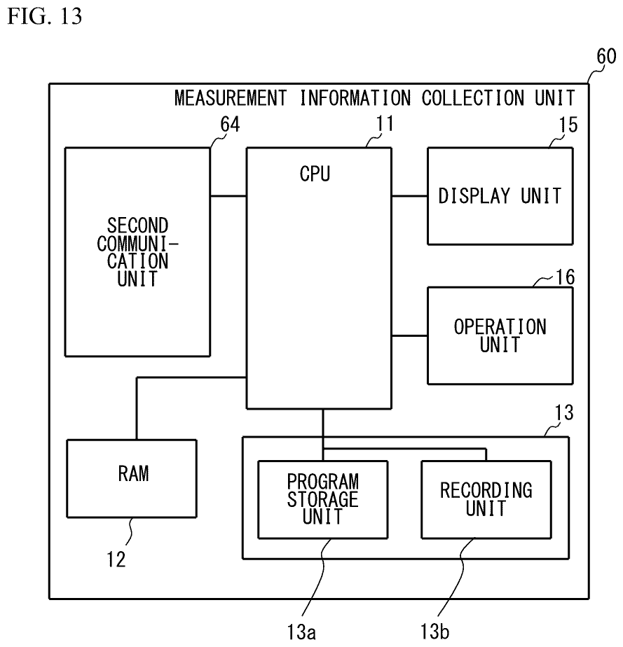

The measurement information collection unit 60 illustrated in FIG. 13 includes the CPU 11, the RAM 12, the storage unit 13, the display unit 15, and the operation unit 16, as in the measurement information management device 10 of the first embodiment. A second communication unit 64 is provided instead of the first wireless transceiver unit 14.

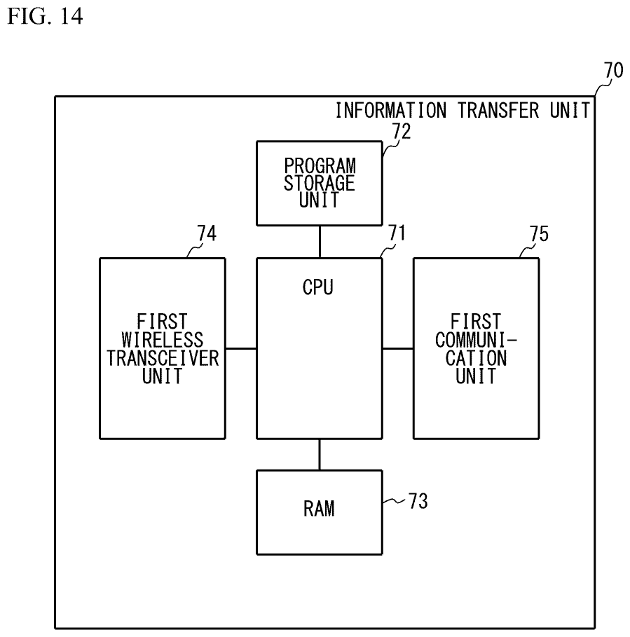

The information transfer unit 70 illustrated in FIG. 14 includes a CPU 71, a program storage unit 72, a RAM 73, a first wireless transceiver unit 74, and a first communication unit 75. The first wireless transceiver unit 74 corresponds to the first wireless transceiver unit 14 in the first embodiment. The first communication unit 75 communicates with the second communication unit 64 through the communication line 80.

The measurement system 200 of the second embodiment can improve the communication speed in the measurement system 200 by separately providing the information transfer unit 70. The SSD or the HDD used as the storage unit 13 is generally a large-capacity and low-speed device. Therefore, it is assumed that the CPU 11 is occupied at the timing of writing to the storage unit 13. Therefore, in the measured information management device 10 illustrated in FIG. 2, the operation of the first wireless transceiver unit 14 may be affected while the CPU 11 is occupied. The operation of the first wireless transceiver unit 14 requires real-time performance. Therefore, in the measurement system 200 of the second embodiment, the measurement information management unit 50 is divided into the measurement information collection unit 60 including the storage unit 13 and the information transfer unit 70 not including the storage unit. The CPU 71 included in the information transfer unit 70 does not exchange data with the storage unit that is a low-speed device. Thereby, the processing speed of the first wireless transceiver unit 74 and the first communication unit 75 is improved, and the real-time property of wireless transceiver is secured. As a result, the processing speed of the measurement system 200 as a whole is also improved.

Although the embodiments of the present invention have been described in detail above, the present invention is not limited to the specific embodiments, and various modifications and changes can be made within the scope of the gist of the present invention described in the claims.

What is claimed is:

1. A measurement information management device comprising:
a measurement information management circuitry that transmits a measurement command signal, receives a measurement result signal transmitted from each of a plurality of measurement instruments, and manages a plurality of measurement result signals,
wherein the measurement information management circuitry includes a first wireless transceiver that transmits the measurement command signal by a first communication scheme and receives the measurement result signal, and
wherein the first wireless transceiver performs transmission of the measurement command signal a plurality of times at different timings using different radio frequency channels, and receives the measurement result signals transmitted at mutually different timings by second wireless transceivers included in the plurality of measurement instruments, respectively, according to a second communication scheme having a radio frequency band different from that of the first communication scheme.

2. The measurement information management device according to claim 1,
wherein the first communication scheme is a wireless scheme having a higher communication speed than a wireless scheme used in the second communication scheme.

3. The measurement information management device according to claim 1,
wherein the first communication scheme is a broadcast communication scheme, and the second communication scheme is a unicast communication scheme.

4. The measurement information management device according to claim 1,
wherein the first wireless transceiver sets a time interval of the measurement command signal to a different time interval when the measurement command signal is executed a plurality of times.

5. The measurement information management device according to claim 1,
wherein the measurement information management circuitry assigns identifiers to the plurality of measurement instruments, and
wherein the first wireless transceiver receives the measurement result signals sequentially transmitted based on the identifiers by the second wireless transceivers included in the measurement instruments that have successfully received the measurement command signal.

6. The measurement information management device according to claim 1,
wherein the first wireless transceiver receives the measurement result signals retransmitted a plurality of times by the second communication scheme within a predetermined time.

7. The measurement information management device according to claim 6,
wherein the predetermined time is changeable.

8. The measurement information management device according to claim 6,
wherein the first wireless transceiver receives the measurement result signals equal to or less than a number corresponding to the number of times that the second wireless transceivers are capable of retransmitting within the predetermined time.

9. A measurement method comprising:
executing, by a measurement information management circuitry, a measurement command signal according to a first communication scheme a plurality of times at different timings using different radio frequency channels; and
receiving, by the measurement information management circuitry, measurement result signals obtained by wirelessly transmitting measurement results measured by a plurality of measurement instruments that have received the measurement command signal at mutually different timings by a second communication scheme having a radio frequency band different from that of the first communication scheme.

10. A measurement instrument comprising:
a processor; and
a measurement tool;
wherein the processor is configured to:
receive a measurement command signal transmitted a plurality of times from a measurement information management device by a first communication scheme while changing a radio frequency channel and a transmission timing;
start measurement by the measurement tool in response to the measurement command signal to acquire a measurement result; and
transmit a measurement result signal to the measurement information management device at a timing different from that of another measurement instrument by a second communication scheme having a radio frequency band different from that of the first communication scheme.
